(19) United States
(12) Patent Application Publication
(10) Pub. No.: US 2016/0345509 A1
(43) Pub. Date: Dec. 1, 2016

(54) OUTDOOR PLANTER WITH OPEN BOTTOM AND REMOVABLE CAP

(71) Applicant: Drahoslava Bejdova, Lake Mary, FL (US)

(72) Inventor: Drahoslava Bejdova, Lake Mary, FL (US)

(21) Appl. No.: 14/722,202

(22) Filed: May 27, 2015

(51) Int. Cl. A01G 9/02

(52) U.S. Cl. CPC A01G 9/02; A01G 2009/003

(57) ABSTRACT

An outdoor planter includes a main body having a continuous side wall, an open top and an open bottom end. The side wall receives a plant, soil and a root system, and the open bottom end engages the ground allowing the roots to extend outward below ground. A series of protrusions can be disposed along the bottom end of the planter, and function to penetrate the ground layer to provide stability. A bottom cap is removably secured to the bottom end of the planter to allow the plant and planter to be transported from one location to another.

### TECHNICAL FIELD

The present invention relates generally to planters, and more particularly to a planter having an open bottom end with a removable cap section.

### BACKGROUND

The statements in this section merely provide background information related to the present disclosure and may not constitute prior art.

Virtually any plant that is purchased from a nursery or other such location is positioned within a pot/planter. As such, the size and shape of the planter is typically proportional to the size and shape of the plant itself, and it functions to allow the plant to be transported without causing damage to the delicate root system.

Once arriving at the final destination, the owner may choose to remove the plant from the pot and replant it into the ground. As such, upon removing the plant, the planter has no practical use or value to the owner who will typically discard the planter, causing the same to end up in a landfill. Alternatively, the owner may choose to leave the plant within the pot and simply position it at a desirable location in an outdoor garden. This is especially preferable for young plants, as the planter affords the root system extra protection against extreme weather conditions, soil erosion and other such factors which can damage or kill the plant. The planter also functions to retain water and prevent runoff of the same. Moreover, recent advancements in construction methodologies have seen the introduction of plant pots which include fanciful shapes, construction materials and/or decorative elements that function to greatly enhance the garden area in which the potted plant is located.

Owing to the above, it is becoming increasingly popular to leave outdoor plants within a planter for as long as possible. Unfortunately, over time the root system will outgrow the size of the planter. When this occurs, the plant must be removed, or the plant itself will become sick and eventually die. When this occurs, the planter itself will again become useless to the owner and will be discarded.

Accordingly, it would be beneficial to provide an outdoor garden planter which can be utilized for the life of the plant, and that does not suffer from the drawbacks of the above noted devices.

### SUMMARY OF THE INVENTION

The present invention is directed to a planter for use in an outdoor environment. One embodiment of the present invention can include a main body having a continuous side wall, an open top and an open top end. The open top can receive a plant, soil and a root system, and the sidewall can encircle the same. The bottom end of the planter can be positioned on the ground in a garden or other such location, and the open bottom end can allow the roots to extend outward below ground.

Another embodiment of the present invention can include a series of protrusions that are disposed along the bottom end of the planter. The protrusions can penetrate the ground layer, and function to stabilize the planter. Yet another embodiment of the present invention can include a bottom cap which can be removably secured to the bottom end of the planter. The cap can function to allow a plant contained within the planter to be transported from one location to another.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an outdoor planter that is useful for understanding the inventive concepts disclosed herein.

FIG. 2 is a perspective view of the outdoor planter in accordance with another embodiment of the invention.

FIG. 3 is a perspective view of the outdoor planter in operation, in accordance with one embodiment of the invention.

FIG. 4A is a perspective view of the outdoor planter in accordance with another embodiment of the invention.

FIG. 4B is a perspective view of the outdoor planter in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured,” and derivatives thereof shall be used to describe a situation wherein two or more objects are joined together in a non-permanent manner so as to allow the same objects to be repeatedly joined and separated.

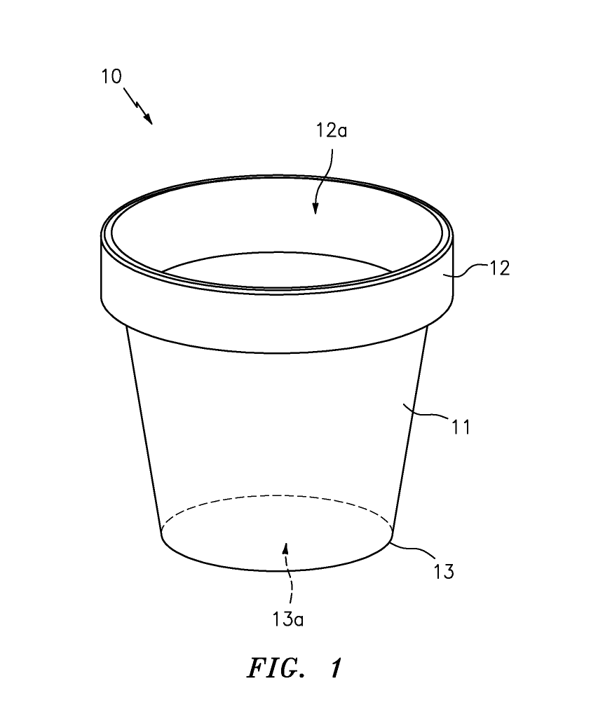

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

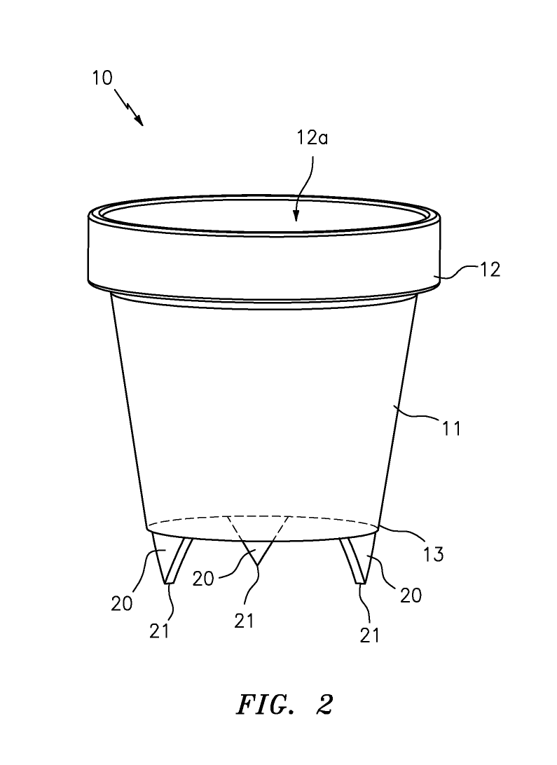

FIGS. 1 and 2 illustrate various embodiments of a planter 10 that is useful for understanding the inventive concepts disclosed herein. As shown, the planter can include a main body that comprises a continuous, generally frustoconical shaped outer wall 11 having an upper edge 12 defining a top opening 12a, and a bottom edge 13 defining a lower opening 13a. The main body defining a generally hollow interior space for receiving and encircling the root system of a plant. In one embodiment, a series of protrusions 20 can extend downward from the bottom edge 12 of the outer wall 11.

As described herein, the planter 10 can be constructed from any number of different materials that are suitable for prolonged use in an outdoor environment. Several nonlimiting examples include plastic, clay and various earthenware pottery. Moreover, the planter can include any number of decorative elements such as various colors, markings, words, shapes, symbols, logos, designs, texturing of materials, patterns, and images, which can be secured onto and/or into the outer wall in accordance with known techniques so as to be flush with the surface thereof, or to be raised/protruding outward therefrom, so as to give a three dimensional effect.

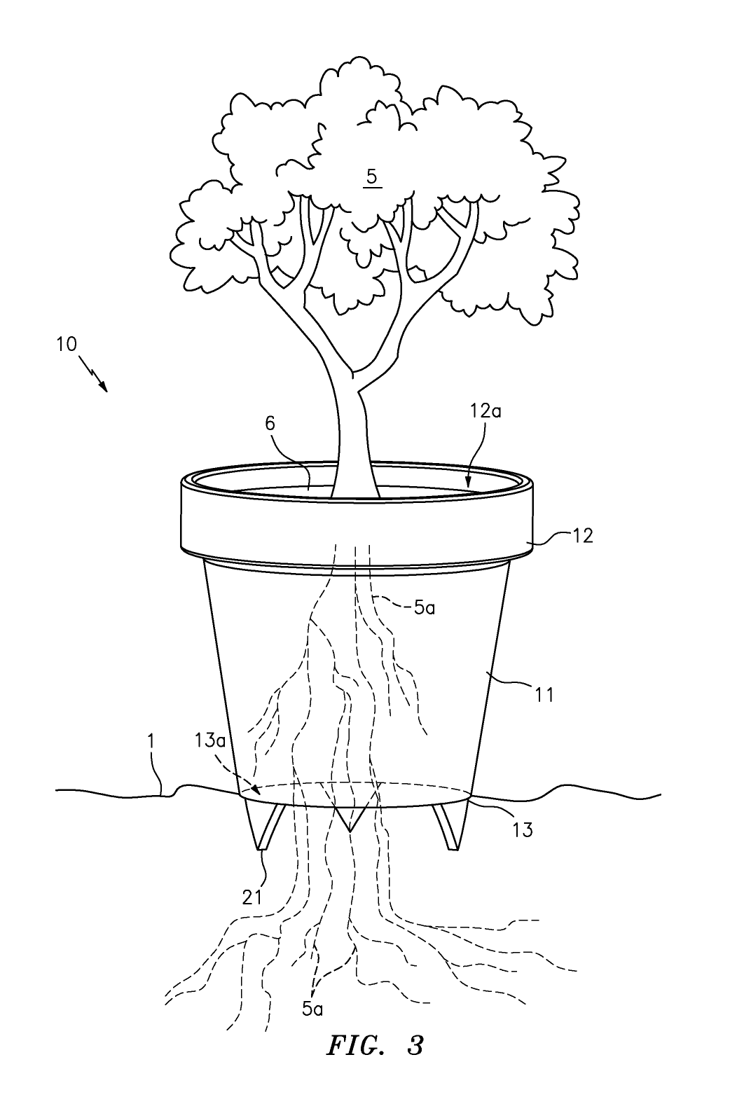

FIG. 3 illustrates one embodiment of the device 10 in operation. As shown, the device 10 can be placed in a garden or other outdoor space so that the bottom edge 13 is flush with the ground 1. In this regard, the distal end 21 of each protrusion can include a generally sharp surface which can easily penetrate the ground, so as to allow the protrusions to be located beneath the ground, thereby stabilizing the installed planter. At this time, the bottom end of the plant 5 containing the roots 5a and any planting soil 6 can be deposited within the open top end of the planter 12a. Over time, the roots 5a will grow beyond the borders of the planter 10, and can freely move through the open bottom end 13a, so as to access ground water and provide long term stability for the plant.

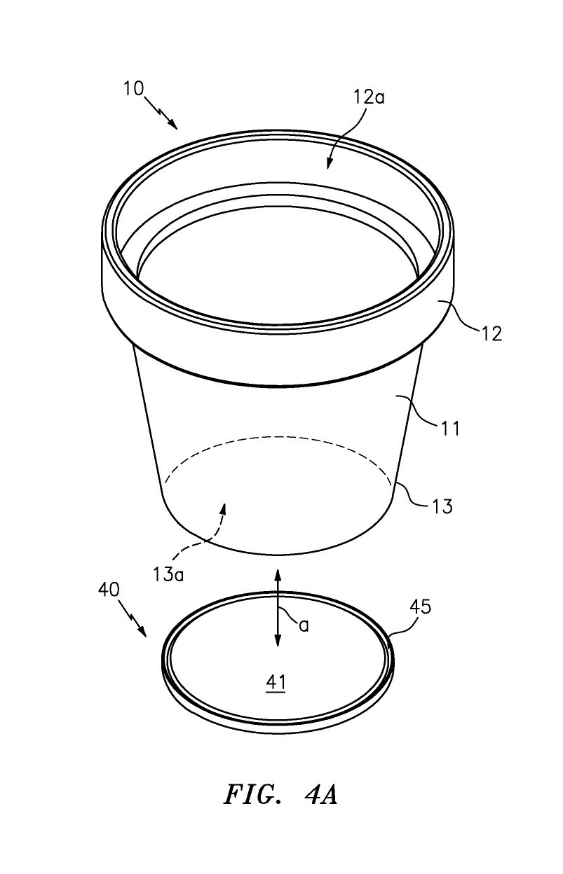

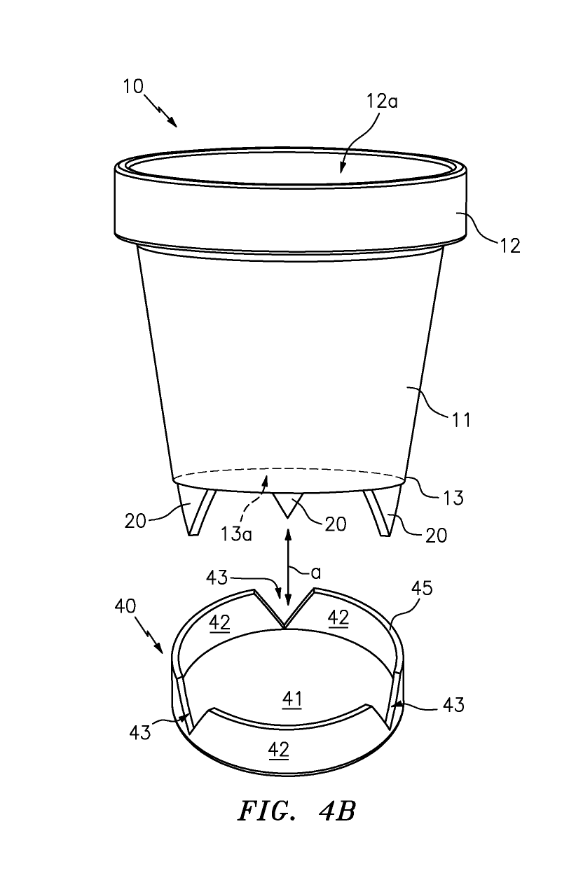

FIGS. 4A and 4B illustrates a removable bottom cap section 40 that includes a generally planar bottom end member 41 having a shape and dimension that is complementary to the shape and dimension of the open bottom end 13a of the planter. As shown, the cap section can include a generally smooth outer edge, or can include an upward radiating edge 42 having a series of indentations 43 which correspond to the above described protrusions 20. In either instance, a sealing mechanism 45 such as a V-shaped lip, for example, can be disposed along the outer edge of the planar member 41 and/or edge 42, and can function to receive and engage (see arrow a) the bottom edge 13 and/or protrusions 20 of the planter 10 in a secure and watertight manner.

In operation, the cap 40 can function to allow a nursery or other such location to offer plants that are pre-loaded within the planter 10, so as to be easily transported by a consumer. Once placed in a garden or other outdoor space, the user can simply remove the cap 40, and install the planter 10 as described above. Such a feature allows users to enjoy the benefits and aesthetics of a potted plant, without long term health concerns to the plant and without creating waste.

As described herein, one or more elements of the planter 10 and cap 40 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A planter, comprising:
a continuous, generally frustoconical shaped outer wall that functions to receive and encircle a plant, soil and a root system;
an upper edge that is disposed along a top end of the outer wall and defining a top opening that is in communication with an inside surface of the outer wall;
a bottom edge that is disposed along a lower end of the outer wall and functioning to engage a ground portion of an outdoor environment,
said lower edge defining a bottom opening that is in communication with the inside surface of the outer wall, and functioning to allow the plant and root system to penetrate the ground portion of the outdoor environment.

2. The planter of claim 1, wherein the outer wall is constructed from a rugged material that is suitable for prolonged exposure to outdoor environments.

3. The planter of claim 1, further comprising:
a plurality of decorative elements that are disposed along the outer wall, said decorative elements functioning to enhance an aesthetic appearance of the planter.

4. The planter of claim 1, further comprising:
a bottom cap having a generally planar member that includes shape and dimension that is complementary to the bottom edge of the outer wall; and
a sealing mechanism that is disposed along a periphery of the planar member, said sealing mechanism functioning to removably engage the bottom edge of the outer wall.

5. The planter of claim 4, wherein the sealing mechanism includes a v-shaped lip that secures the bottom cap and outer wall together in a watertight manner.

6. The planter of claim 1, further comprising:
a series of protrusions that are disposed along the bottom edge of the outer wall.

7. The planter of claim 6, wherein each of the protrusions further includes a distal end having a sharp surface that functions to penetrate the ground portion of the outdoor environment.

8. The planter of claim 7, further comprising:
a bottom cap having a generally planar member that includes shape and dimension that is complementary to the bottom edge of the outer wall;
an upward radiating edge that is disposed along a periphery of the planar member;
a plurality of indentations that are disposed along the upward radiating edge, each of the indentations including a shape, size and location that is complementary to the series of protrusions; and
a sealing mechanism that is disposed along a periphery of the upward radiating edge, said sealing mechanism functioning to removably engage each of the series of protrusions and the bottom edge of the outer wall.

9. The planter of claim 8, wherein the sealing mechanism includes a v-shaped lip that secures the bottom cap and outer wall together in a watertight manner.
